(19) United States
(12) Patent Application Publication
(10) Pub. No.: US 2019/0009957 A1
(43) Pub. Date: Jan. 10, 2019

(54) TAMPER EVIDENT SEAL INCORPORATING FLEXIBLE MEMORY DEVICES

(71) Applicant: Xerox Corporation, Norwalk, CT (US)

(72) Inventors: Aaron M. Stuckey, Fairport, NY (US); Jeffrey M. Fowler, Rochester, NY (US); Amit Trivedi, Webster, NY (US); Karl E. Kurz, Rochester, NY (US)

(21) Appl. No.: 15/641,694

(22) Filed: Jul. 5, 2017

(51) Int. Cl. B65D 55/06; A61J 1/03; G06K 19/077

(52) U.S. Cl. CPC B65D 55/06; G06K 19/0772; A61J 1/03

(57) ABSTRACT

A flexible memory device including a flexible substrate, a plurality of contact pads, a plurality of lines and a first partially weakened portion of the flexible substrate. The plurality of contact pads are disposed on the flexible substrate. At least one contact pad of the plurality of contact pads forms at least one first tamper evident pad. The plurality of lines are disposed on the flexible substrate, each line of the plurality of lines connected to a contact pad of the plurality of contact pads. At least one line of the plurality of lines forms at least one first tamper evident line and is connected to the at least one first tamper evident contact pad. The first partially weakened portion of the flexible substrate is arranged across the at least one tamper evident line.

### TECHNICAL FIELD

The presently disclosed embodiments are directed to providing a flexible memory device, more particularly to a product seal, tag and/or tracking means including a flexible memory device, and even more particularly to a product seal, tag and/or tracking means including a flexible memory device that evidences tampering or modification, e.g., intentional and/or selective lead destruction, while maintaining a portion of data stored in the memory device.

### BACKGROUND

Flexible memory devices, e.g., printed memory (PM) labels and devices, are manufactured in a variety of sizes, including but not limited to twenty bit (20-bit), twenty-five bit (25-bit) and thirty-six bit (36-bit), which each have various arrangements of electrical contacts or contact pads. An example of a known 20-bit printed memory device is depicted in FIG. 1. As is known in the art, printed memory devices typically comprise seven layers: a base substrate layer; a bottom electrode layer; a ferrite layer; a top electrode layer; contact pads; a soft protective layer; and, a hard protective layer. The ferrite layer is arranged between the bottom and top electrode layers. Memory is stored in a discrete cell, i.e., a particular portion of the ferrite layer, an appropriate voltage pattern must be applied across contact pads connected to the bottom and top electrode layers associated with the particular portion of the ferrite layer.

Products and product packaging may be subjected to tampering or counterfeiting. Products such as popular liquors and cigarettes, for example, are at times adulterated or replaced with knock off products in order for others to profit from the theft and deception. Thus, there is a need for a device that can both seal a product and ensure the product is what it is intended to be.

The present disclosure sets forth a seal or tag containing a flexible memory device that can be disabled in whole or in part so that any tampering after the product has left the original manufacturer is detectable. It makes it possible to track if the seal or tag has been broken post manufacture. Moreover, information about the product or the status of the product retained in memory, before and after the seal or tag, or a portion of the seal or tag, is broken can further minimize the foregoing issues. Tampering with the product and breaking the seal or tag may disable the ability to read part or all of the information stored in the flexible memory device.

### SUMMARY

This invention proposes to re-route one or more leads in a flexible memory device such that they connect memory cells to contact pads via a perforated area. When the perforation is torn, the connection is broken between the memory cells and the contact pad.

Broadly, the present disclosure sets forth embodiments of a flexible memory device including a flexible substrate, a plurality of contact pads, a plurality of lines and a first partially weakened portion of the flexible substrate. The plurality of contact pads are disposed on the flexible substrate. At least one contact pad of the plurality of contact pads forms at least one tamper evident contact pad. The plurality of lines are disposed on the flexible substrate, each line of the plurality of lines connected to a contact pad of the plurality of contact pads. At least one line of the plurality of lines forms at least one first tamper evident line and is connected to the at least one first tamper evident contact pad. The first partially weakened portion of the flexible substrate is arranged across the at least one tamper evident line.

Other objects, features and advantages of one or more embodiments will be readily appreciable from the following detailed description and from the accompanying drawings and claims.

### BRIEF DESCRIPTION OF THE DRAWINGS

Various embodiments are disclosed, by way of example only, with reference to the accompanying drawings in which corresponding reference symbols indicate corresponding parts, in which:

FIG. 1 is a top plan view of an embodiment of a known 20-bit flexible memory device;

FIG. 2 is a top plan view of an embodiment of a 20-bit tamper evident flexible memory device;

FIG. 3 is a top plan view of an embodiment of a 20-bit tamper evident flexible memory device;

FIG. 4 is a top plan view of an embodiment of a 20-bit tamper evident flexible memory device;

FIG. 5 is top plan view of an embodiment of a known 25-bit flexible memory device;

FIG. 6 is a top plan view of an embodiment of a 25-bit tamper evident flexible memory device;

FIG. 7 is a top plan view of an embodiment of a 25-bit tamper evident flexible memory device;

FIG. 8 is a table depicting various configurations for an embodiment of a 25-bit tamper evident flexible memory device, wherein 5-25 bits may be disabled or obscured by interrupting 1-8 leads;

FIG. 9 is a top plan view of an embodiment of a known 36-bit flexible memory device;

FIG. 10 is a top plan view of an embodiment of a 36-bit tamper evident flexible memory device;

FIG. 11 is a top plan view of an embodiment of a 36-bit tamper evident flexible memory device;

FIG. 12 is a top plan view of an embodiment of a 36-bit tamper evident flexible memory device;

FIG. 13 is a top plan view of an embodiment of a 25-bit tamper evident flexible memory device;

FIG. 14 is a side elevational view of an embodiment of a 25-bit tamper evident flexible memory device;

FIG. 15 is a back elevational view of an embodiment of a packaging bag including an embodiment of a 25-bit tamper evident flexible memory device; and,

FIG. 16 is a side elevational view of an embodiment of a container including an embodiment of a 25-bit tamper evident flexible memory device.

### DETAILED DESCRIPTION

At the outset, it should be appreciated that like drawing numbers on different drawing views identify identical, or functionally similar, structural elements of the embodiments set forth herein. Furthermore, it is understood that these embodiments are not limited to the particular methodologies, materials and modifications described and as such may, of course, vary. It is also understood that the terminology used herein is for the purpose of describing particular aspects only, and is not intended to limit the scope of the disclosed embodiments, which are limited only by the appended claims.

Unless defined otherwise, all technical and scientific terms used herein have the same meaning as commonly understood to one of ordinary skill in the art to which these embodiments belong. As used herein, “weakened portion”, for example a weakened portion of a flexible substrate, is intended to mean a portion of an original structure that has been modified, altered or formed in such a way that a force required to sever the weakened portion is less than the severing force required for the original structure. Examples of “weakened portions” include but are not limited to perforations, notches, partial cuts, decreased material thickness, etc.

It should be understood that use of “or” in the present application is with respect to a “non-exclusive” arrangement, unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

Moreover, although any methods, devices or materials similar or equivalent to those described herein can be used in the practice or testing of these embodiments, some embodiments of methods, devices, and materials are now described.

The present disclosure sets forth various embodiments of flexible memory devices, e.g., flexible printed memory devices, arranged to evidence tampering and/or arranged to positively indicate the occurrence of an action, e.g., inspection of an article.

FIG. 1 depicts an embodiment of a known 20-bit flexible memory device, i.e., printed memory device 50. Device 50 includes flexible substrate 52 having contact pads 54 and lines 56 disposed thereon. Common line 58, connected to contact pads 59, is separated from lines 56 by a ferrite layer as described above, and lines 56 are connected to contact pads 54. A single bit of memory is formed by each portion of the ferrite layer located at the depicted intersections of common line 58 and lines 56.

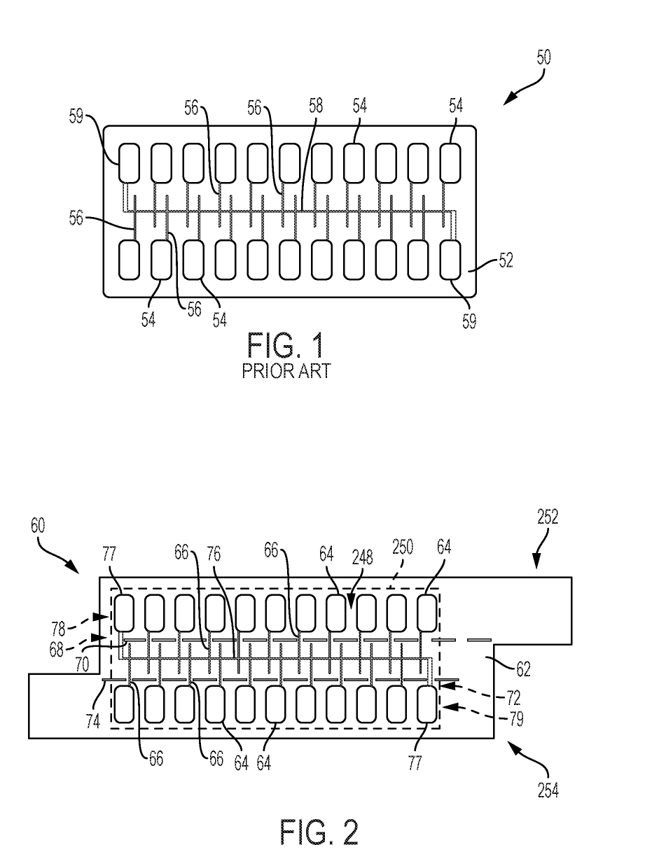

FIG. 2 depicts an embodiment of a presently described 20-bit tamper evident flexible memory device 60. Device 60 comprises flexible substrate 62 having contact pads 64 and interconnecting lines 66 disposed thereon. Moreover, device 60 comprises a plurality of leads or lines routed across a first perforation, and a plurality of leads or lines routed across a second perforation. In other terms, tamper evident lines 68 are routed across weakened portion 70, while tamper evident lines 72 are routed across weakened portion 74. Common line 76 is connected to contact pads 77 and is separated from lines 66 by a ferrite layer as described above.

In an example embodiment, a write operation would write a 0 value to tamper evident contact pads 78 connected to tamper evident lines 68. When perforation 70 is torn or severed, a read operation will yield a value of 1 for these bits, regardless of the 0 value that was originally written. In this example embodiment, the bits of memory act to detect whether perforation 70 has been torn or severed, i.e., whether flexible memory device 60 was subject to tampering or its associated packaging opened. Moreover, if a second indication of tampering is required, device 60 may also be arranged such that perforation 74 may be severed simultaneously as or at a different time than perforation 70, thereby permitting a similar instance of bit storage for tamper evident contact pads 79.

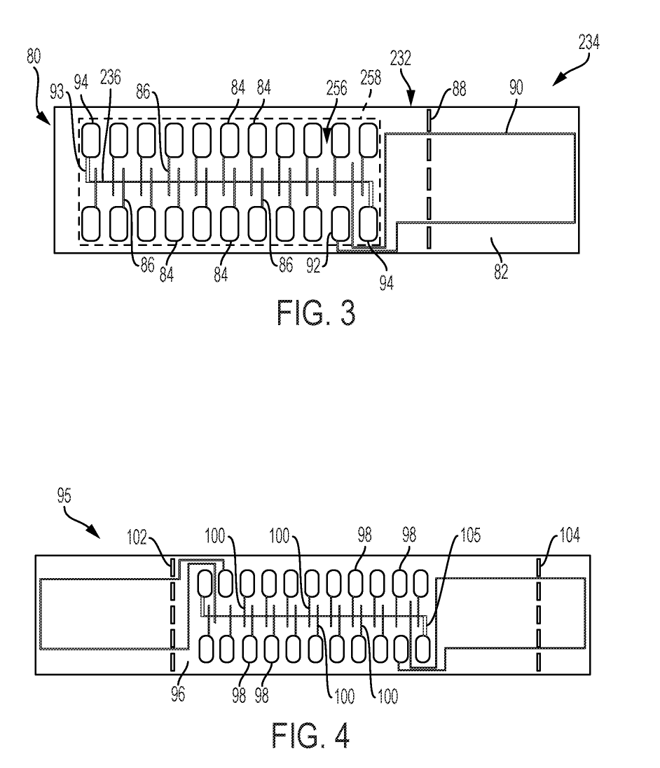

It should be appreciated that the foregoing arrangement of tamper evident contact pads and tamper evident lines is not limited to embodiments where all lines on a particular side of device 60 are simultaneously severed. For example, FIG. 3 depicts a 20-bit tamper evident flexible memory device, i.e., device 80. Device 80 includes flexible substrate 82 having contact pads 84 and lines 86 thereon, and further includes weakened portion 88 therethrough. In this embodiment, tamper evident line 90 is the only line passing across weakened portion 88. Thus, severing weakened portion 88 severs tamper evident line 90 thereby altering the bit value readable from tamper evident contact pad 92, while the remaining lines 86 and common line 93 are not severed. It should be appreciated that contact pads 94 are connected to common line 93, while contact pads 84 are connected to lines 86. Moreover, FIG. 4 depicts an embodiment of a 20-bit tamper evident flexible memory device 95 including flexible substrate 96 having contact pads 98 and lines 100 thereon, and further includes weakened portions 102 and 104 therethrough. In this embodiment, two levels or instances of change may be detected, i.e., the severing of weakened portion 102 (the first instance) and the severing of weakened portion 104 (the second instance). Similar to the embodiment depicted in FIG. 3, both instances result in common line 105 and at least a portion of lines 100 remaining intact.

FIG. 5 depicts an embodiment of a known 25-bit flexible memory device, i.e., printed memory device 106. Device 106 includes flexible substrate 108 having contact pads 110, contact pads 111 and lines 112 disposed thereon. Lines 112 comprise a first portion, i.e., lines 113, connected to contact pads 110 and a second portion, i.e., lines 114, connected to contact pads 111. It should be appreciated that lines 113 are arranged to pass over lines 114 with a ferrite layer disposed therebetween, as described above with respect to other embodiments. A single bit of memory is formed by each portion of the ferrite layer located at the depicted intersections of lines 113 and lines 114.

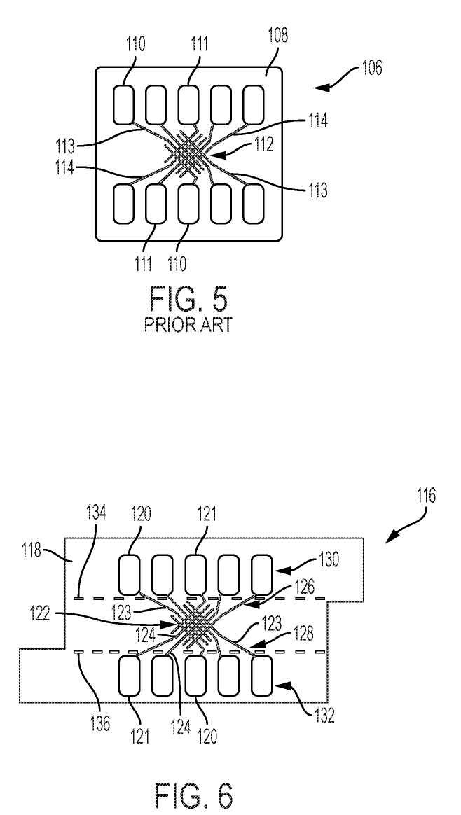

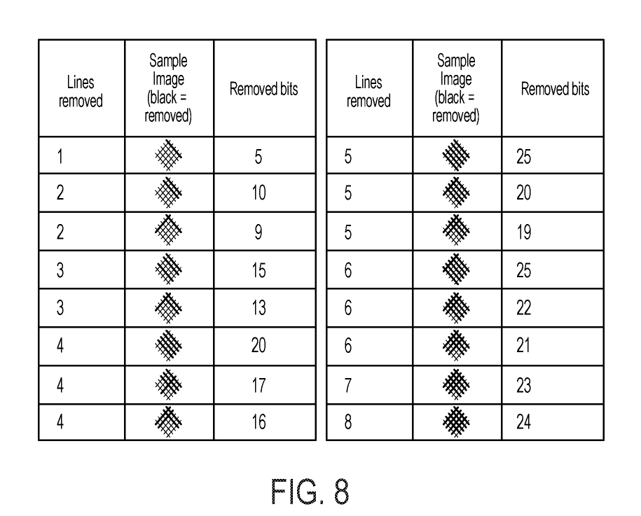

FIG. 6 depicts an embodiment of a 25-bit tamper evident flexible memory device, i.e., device 116. Device 116 comprises flexible substrate 118 having contact pads 120, contact pads 121 and lines 122 disposed thereon. Lines 122 comprise a first portion, i.e., lines 123, connected to contact pads 120 and a second portion, i.e., lines 124, connected to contact pads 121. It should be appreciated that lines 123 are arranged to pass over lines 124 with a ferrite layer disposed therebetween, as described above with respect to other embodiments. A single bit of memory is formed by each portion of the ferrite layer located at the depicted intersections of lines 123 and lines 124. In this embodiment, a portion of lines 123 and a portion of lines 124 are tamper evident lines 126 while the remaining lines 123 and 124 are tamper evident lines 128. Each of tamper evident lines 126 is connected to tamper evident contact pad 130 at a first end, while each of tamper evident lines 128 is connected to tamper evident contact pad 132 at a first end. Tamper evident lines 126 each pass across weakened portion 134, and tamper evident lines 128 each pass across weakened portion 136. By severing one of weakened portions 134 or 136, device 116 retains some quantity of data bits in accordance with the depiction in FIG. 8 and the discussion related thereto below, while severing both of weakened portions 134 and 136, device 116 obscures all of the stored data bits.

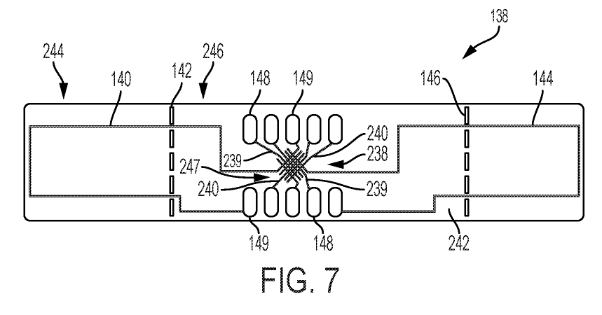

FIG. 7 depicts an embodiment of a 25-bit tamper evident flexible memory device, i.e., device 138. Device 138 comprises two leads or lines routed across two different perforations or weakened portions. In other terms, tamper evident line 140 is routed across weakened portion 142, while tamper evident line 144 is routed across weakened portion 146. In this example embodiment, contact pads 148 and 149 are formed in rows, and there is one tamper evident line that is disabled by tearing either perforation. Four additional bits are disabled by tearing perforation or weakened portion 142, and a further four additional bits are disabled by tearing perforation or weakened portion 146. The foregoing arrangement facilitates a variety of uses for device 138. For example, device 138 may be secured to a product packaging and facilitate the recording of the passage of the product through two stages of a process, while obscuring some of the data used earlier in the process. In other terms, data bits may be written to device 138 at the onset. Subsequently, device 138 is attached to a product or product packaging. As the product moves through its process, weakened portion 142 is severed to obscure a portion of the data bits stored on device 138, while retaining other data bits. Then, later in the process, weakened portion 146 is severed thereby obscuring additional bits of data.

FIG. 8 depicts various configurations available for a 25-bit flexible memory device, by which 5-25 bits may be disabled or obscured by interrupting 1-8 leads. It should be appreciated that FIG. 8 does not depict all possible arrangements of severing lines, but depicts a set of non-limiting examples. The table in FIG. 8 shows how removing the same number of lines can result in differing numbers of removed bits, e.g., removing four lines could result in removing 16, 17 or 20 bits.

FIG. 9 depicts a known 36-bit flexible memory device, i.e., device 150. Device 150 includes flexible substrate 152 having contact pads 154, contact pads 155 and lines 156 disposed thereon. Lines 156 comprise a first portion, i.e., lines 157, connected to contact pads 154 and a second portion, i.e., lines 158, connected to contact pads 155. It should be appreciated that lines 157 are arranged to pass over lines 158 with a ferrite layer disposed therebetween, as described above with respect to other embodiments. A single bit of memory is formed by each portion of the ferrite layer located at the depicted intersections of lines 157 and lines 158.

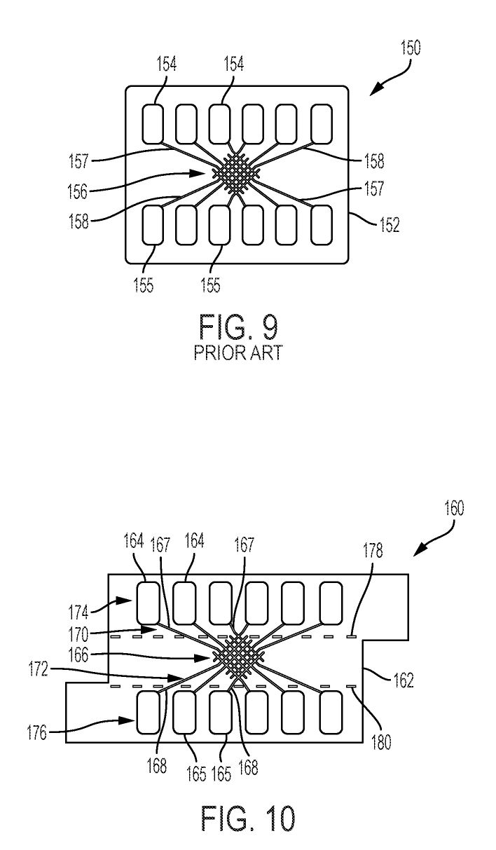

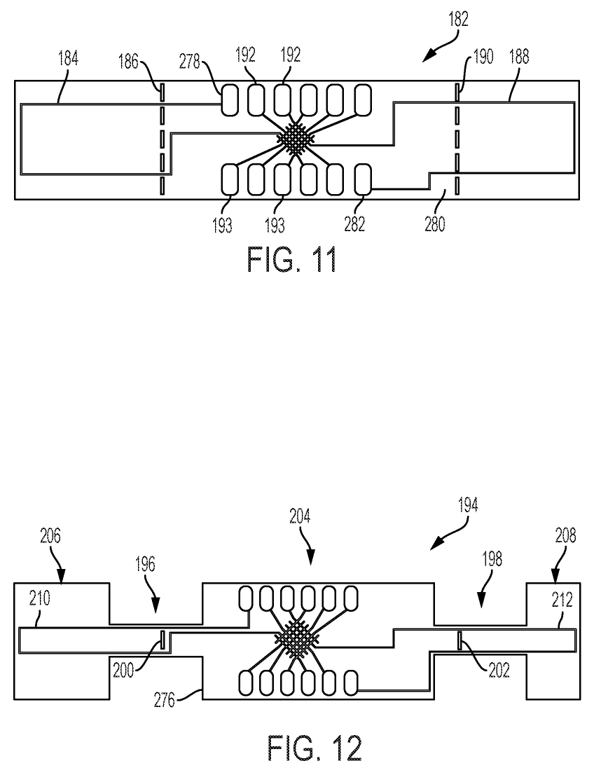

FIG. 10 depicts an embodiment of a 36-bit tamper evident flexible memory device, i.e., device 160. Device 160 comprises flexible substrate 162 having contact pads 164, contact pads 165 and lines 166 disposed thereon. Lines 166 comprise a first portion, i.e., lines 167, connected to contact pads 164 and a second portion, i.e., lines 168, connected to contact pads 165. It should be appreciated that lines 167 are arranged to pass over lines 168 with a ferrite layer disposed therebetween, as described above with respect to other embodiments. A single bit of memory is formed by each portion of the ferrite layer located at the depicted intersections of lines 167 and lines 168. In this embodiment, a portion of lines 167 and a portion of lines 168 are tamper evident lines 170 while the remaining lines 167 and 168 are tamper evident lines 172. Each of tamper evident lines 170 is connected to tamper evident contact pad 174 at a first end, while each of tamper evident lines 172 is connected to tamper evident contact pad 176. Tamper evident lines 170 each pass across weakened portion 178, and tamper evident lines 172 each pass across weakened portion 180. By severing one of weakened portions 178 or 180, device 160 retains some quantity of data bits in accordance with the depiction in FIG. 8 and the discussion related thereto above, while severing both of weakened portions 178 and 180, device 160 obscures all of the stored data bits.

FIG. 11 depicts an embodiment of a 36-bit tamper evident flexible memory device, i.e., device 182. Device 182 comprises two leads or lines routed across two different perforations or weakened portions. In other terms, tamper evident line 184 is routed across weakened portion 186, while tamper evident line 188 is routed across weakened portion 190. In this example embodiment, contact pads 192 and 193 are formed in rows. The foregoing arrangement facilitates a variety of uses for device 182, for example, uses as described above relative to FIG. 7.

FIG. 12 depicts an embodiment of a 36-bit tamper evident flexible memory device, i.e., device 194. Device 194 depicted in FIG. 12 is configured substantially the same as device 182 depicted in FIG. 11; however, device 194 includes narrowed regions 196 and 198 having weakened portions 200 and 202, respectively, arranged therein. The shape of device 194 makes it appropriate for placing over the top of a bottle or jar, such that at least one perforation or weakened portion 200 and/or 202 is torn when the container is opened. In other terms, central portion 204 is secured to the top of a bottle, for example, while distal portions 206 and 208 are secured to the body of the bottle adjacent the top. When the bottle is opened, one or both of weakened portions 200 and/or 202 are severed thereby severing tamper evident leads 210 and/or 212, and narrowed regions 196 and/or 198.

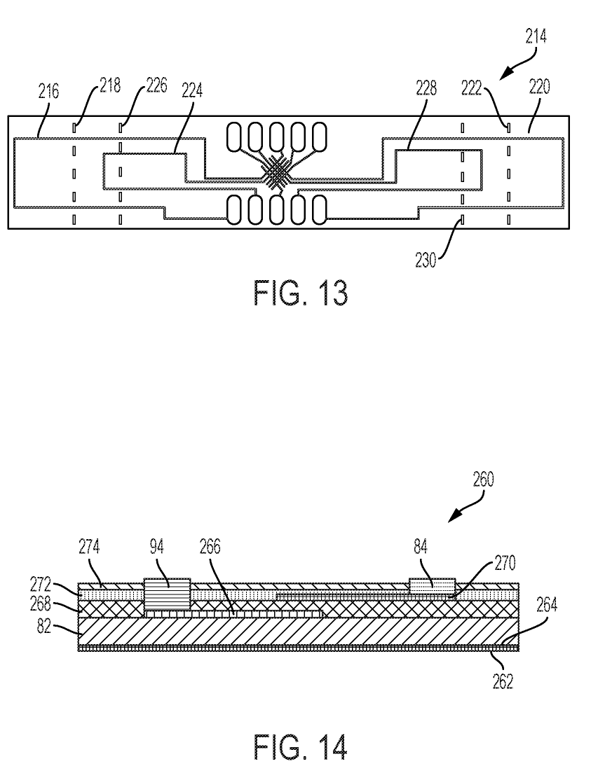

FIG. 13 depicts an embodiment of a 25-bit tamper evident flexible memory device, i.e., device 214. Device 214 comprises four leads or lines routed across four different perforations or weakened portions. In other terms, tamper evident line 216 is routed across weakened portion 218, tamper evident line 220 is routed across weakened portion 222, tamper evident line 224 is routed across weakened portion 226, and tamper evident line 228 is routed across weakened portion 230. The foregoing arrangement facilitates a variety of uses for device 214. For example, device 214 may be secured to a product packaging and facilitate the recording of the passage of the product through four stages of a process, while obscuring some of the data used earlier in the process. In other terms, data bits may be written to device 214 at the onset. Subsequently, device 214 is attached to a product or product packaging. As the product moves through its process, weakened portion 218 is severed to obscure a portion of the data bits stored on device 214, while retaining other data bits. Then, later in the process, weakened portions 222, 226 and 230 are severed thereby obscuring additional bits of data.

The following is best understood in view of the accompanying figures, which figures are individually described in greater detail above. The present disclosure sets forth various embodiments of flexible memory devices, e.g., flexible printed memory devices arranged to evidence tampering and/or arranged to positively indicate the occurrence of an action, e.g., inspection of an article. Although the embodiments described below may discuss elements contained within a single figure, the embodiments are not limited to a single configuration, and various aspects of some embodiments may be combined with various aspects of other embodiments.

In some embodiments, flexible memory device 80 comprises flexible substrate 82, plurality of contact pads 84, plurality of lines 86 and partially weakened portion 88 of flexible substrate 82. Plurality of contact pads 84 are disposed on flexible substrate 82. At least one contact pad of plurality of contact pads 84 forms at least one tamper evident pad, e.g., tamper evident pad 92. Plurality of lines 86 are disposed on flexible substrate 82 and each line 86 passes over common line 93, as described above, i.e., with a ferrite layer therebetween. At least one line of plurality of lines 86 forms at least one first tamper evident line, e.g., tamper evident line 90. Partially weakened portion 88 of flexible substrate 82 is arranged across the at least one tamper evident line 90.

In some embodiments, plurality of contact pads 84 and plurality of lines 86 are arranged to store a plurality of bits of data. It should be appreciated that the manufacture and encoding of flexible memory devices such as printed memory devices are generally known, and therefore, a detailed description of these aspects is unnecessary.

In some embodiments, partially weakened portion 88 is arranged to separate flexible substrate 82 into first part 232 and second part 234 thereby severing the at least one tamper evident line 90 and the at least one tamper evident pad 92 from plurality of contact pads 84 other than the at least one tamper evident pad 92 and plurality of lines 86 other than the at least one tamper evident line 90. In some embodiments, plurality of contact pads 84 other than the at least one tamper evident pad 92 and plurality of lines 86 other than the at least one tamper evident line 90 store at least one bit of data after severing the at least one tamper evident line 90.

In some embodiments, each of plurality of lines 86 passes over common line 236, as described above, i.e., with a ferrite layer therebetween. In some embodiments, partially weakened portion 88 is arranged to separate flexible substrate 82 into first part 232 and second part 234 without severing common line 236 (See, e.g., FIG. 3).

In some embodiments, plurality of lines 238 comprises a first portion, i.e., lines 239, which pass over a second portion, i.e., lines 240. In some embodiments, partially weakened portion 142 is arranged to separate flexible substrate 242 into first part 244 and second part 246 without severing an area, i.e., area 247, common to lines 239 and 240 (See, e.g., FIG. 7).

In some embodiments, plurality of contact pads 64 and 77 collectively form an area, e.g., area 248 bound by dashed line 250, and partially weakened portion 70 is arranged across area 248 (See, e.g., FIG. 2).

In some embodiments, partially weakened portion 70 is arranged to separate flexible substrate 62 into first part 252 and second part 254, a first group of plurality of contact pads 64 are disposed on first part 252, e.g., contact pads 78, and a second group of plurality of contact pads 64 are disposed on second part 254, e.g., contact pads 79 (See, e.g., FIG. 2).

In some embodiments, plurality of contact pads 84 collectively form an area, e.g., area 256 bound by dashed line 258, and partially weakened portion 88 is arranged outside area 256 (See, e.g., FIG. 3).

In some embodiments, partially weakened portion 88 is arranged to separate flexible substrate 82 into first part 232 and second part 234 and plurality of contact pads 84 are disposed on first part 232 (See, e.g., FIG. 3).

In some embodiments, the presently described flexible memory device 260 comprises adhesive layer 262, e.g., pressure sensitive adhesive, disposed on at least a portion of first surface 264 of flexible substrate 82. Printed memory device 260 comprises seven layers: base substrate layer 82; bottom electrode layer 266; ferrite layer 268; top electrode layer 270; contact pads 84 and 94; soft protective layer 272; and, hard protective layer 274. Ferrite layer 268 is arranged between bottom and top electrode layers 266 and 270, respectively. In some embodiments, partially weakened portion 88 is arranged to separate flexible substrate 82 into first part 232 and second part 234, and adhesive 260 is disposed on first part 232. In some embodiments, partially weakened portion 88 is arranged to separate flexible substrate 82 into first part 232 and second part 234, and adhesive 260 is disposed on a portion of first part 232, e.g., the portion including area 256.

In some embodiments, flexible substrate 276 comprises first part 206, second part 208 and third part 204. Third part 204 is arranged between first and second parts 206 and 208, respectively. Partially weakened portion 200 is arranged between third part 204 and first part 206, and/or partially weakened portion 202 is arranged between third part 204 and second part 208, and adhesive 260 is disposed on at least a portion of first part 206, at least a portion of second part 208 and/or at least a portion of third part 204.

In some embodiments, the presently described flexible memory device comprises at least one first tamper evident contact pad selected from plurality of contact pads, e.g., tamper evident contact pad 278, at least one first tamper evident line selected from plurality of lines, e.g., tamper evident line 184, and connected to the at least one first tamper evident contact pads 278, and further comprising a first partially weakened portion, e.g., weakened portion 186, of flexible substrate 280 arranged across the at least one first tamper evident line, e.g., tamper evident line 184. Additionally, the foregoing flexible memory device comprises at least one second tamper evident contact pad selected from plurality of contact pads, e.g., tamper evident contact pad 282, at least one second tamper evident line selected from plurality of lines, e.g., tamper evident lines 188, and connected to the at least one second tamper evident contact pad 282, and further comprising a second partially weakened portion, e.g., weakened portion 190, of flexible substrate 280 arranged across the at least one second tamper evident line, e.g., tamper evident line 188.

It should be appreciated that the flexible memory devices described herein may be used in a variety of applications. The following provides some non-limiting examples of how and where the present flexible memory devices may be used.

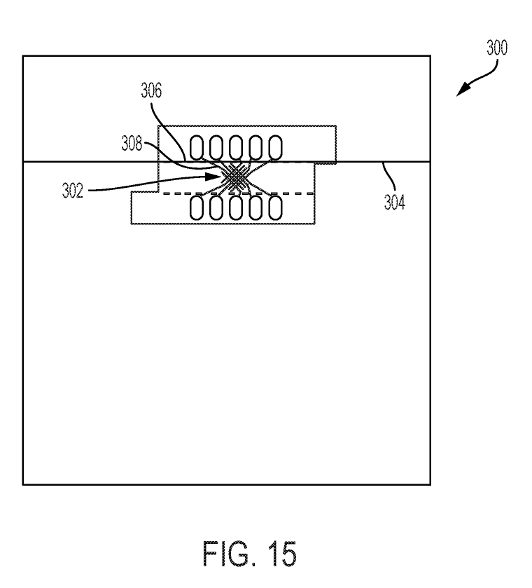

FIG. 15 depicts an embodiment of a packaging bag, i.e., bag 300, including an embodiment of a 25-bit tamper evident flexible memory device, i.e., flexible memory device 302. Bag 300 may be sealed along edge 304 thereby preventing access to the contents of bag 300. Weakened portion 306 of flexible memory device 302 must be severed in order to gain access to the contents. Thus, tampering with bag 300 and potentially the contents therein is readily apparent upon reading the memory stored in flexible memory device 300. As described above, the memory stored in flexible memory device 300 is altered when weakened portion 306 is severed thereby severing tamper evident line 308.

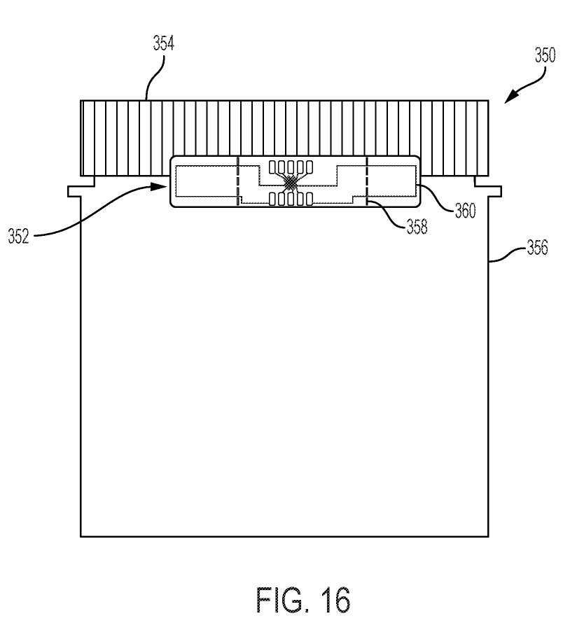

FIG. 16 depicts an embodiment of a container, e.g., pill bottle 350, including an embodiment of a 25-bit tamper evident flexible memory device, i.e., flexible memory device 352. Pill bottle 350 may be sealed along the interface between cap 354 and bottle 356 thereby preventing access to the contents of pill bottle 350. Weakened portion 358 of flexible memory device 352 must be severed in order to gain access to the contents. Thus, tampering with pill bottle 350 and potentially the contents therein is readily apparent upon reading the memory stored in flexible memory device 352. As described above, the memory stored in flexible memory device 352 is altered when weakened portion 358 is severed thereby severing tamper evident line 360.

It should be appreciated that the foregoing examples are non-limiting and that other configurations and uses of the present flexible memory device are also possible. For example, more than one weakened portion may be utilized in preventing tampering with a container's contents. Additionally, other structures or enclosures different than a bag or a pill bottle may be used in combination with a present flexible memory device or devices, e.g., a compact disc jewel case, shipping packages, a carton, a box, a crate, a can, a bottle, an envelope, etc.

Although the various embodiments depicted in the figures and discussed herein include 20-bit, 25-bit and 36-bit flexible memory devices, the presently described flexible memory devices may be used with other embodiments, e.g., 16-bit, or with other memory technologies, including but not limited to write-once printed memory. Depending on configuration, tearing or separating the perforation or weakened portion may disable 0-20 bits of the 20-bit memory, 5-25 bits of the 25-bit memory, or 6-36 bits of the 36-bit memory. In some applications, the presently described flexible memory device permits detection of the tear or severing operation, or alternatively more than one tear or severing operations, while maintaining the function of a portion of the stored memory or data bits on the device. In some applications, the presently described flexible memory device obscures some or all of the stored memory or data bits on the flexible memory device. Moreover, intermediate use cases are also supported. For example, a 25-bit flexible memory device may be configured so that tearing or severing the perforation, i.e., weakened portion, obscures 11 bits of data while leaving 14 bits functional. In other terms, 14 bits of data would remain available for subsequent retrieval from the flexible memory device.

In view of the foregoing it should be appreciated that present disclosure sets forth a tear-able or severable sealing and/or label design using a flexible memory device. Some memory devices, e.g., printed memory devices, are accessed by a memory reader touching contact pads that are printed on a flexible substrate. In such devices, printed conductive traces between the contact pads and the memory device are printed across perforations or weakened portions in the substrate so that strategic bits in the memory device can be made inaccessible by or obscured from the memory reader once the flexible substrate has been torn or severed along the weakened portion. In this way, some memory locations remain functional, while others are rendered non-functional due to the severing or removal of a portion of the substrate. Thus, the presently described flexible memory device provides the ability to selectively disable certain memory locations of the device by tearing/severing/removing a portion of the flexible substrate.

It will be appreciated that various of the above-disclosed and other features and functions, or alternatives thereof, may be desirably combined into many other different systems or applications. Various presently unforeseen or unanticipated alternatives, modifications, variations or improvements therein may be subsequently made by those skilled in the art which are also intended to be encompassed by the following claims.

What is claimed is:

1. A flexible memory device comprising:
a flexible substrate;
a plurality of contact pads disposed on the flexible substrate, at least one contact pad of the plurality of contact pads forms at least one first tamper evident contact pad;
a plurality of lines disposed on the flexible substrate, each line of the plurality of lines connected to a contact pad of the plurality of contact pads, at least one line of the plurality of lines forms at least one first tamper evident line and is connected to the at least one tamper evident contact pad;
a first partially weakened portion of the flexible substrate arranged across the at least one tamper evident line.

2. The flexible memory device of claim 1 wherein the plurality of contact pads and the plurality of lines are arranged to store a plurality of bits of data.

3. The flexible memory device of claim 1 wherein the first partially weakened portion is arranged to separate the flexible substrate into a first part and a second part thereby severing the at least one tamper evident line while leaving the plurality of lines other than the at least one tamper evident line intact.

4. The flexible memory device of claim 3 wherein the plurality of contact pads other than the at least one first tamper evident contact pad and the plurality of lines other than the at least one tamper evident line store at least one bit of data after severing the at least one tamper evident line.

5. The flexible memory device of claim 1 further comprising:
at least one common contact pad;
a common line disposed on the flexible substrate and connected to the at least one common contact pad;
wherein each of the plurality of lines passes over the common line.

6. The flexible memory device of claim 5 wherein the first partially weakened portion is arranged to separate the flexible substrate into a first part and a second part without severing the common line.

7. The flexible memory device of claim 1 wherein a first portion of the plurality of lines passes over a second portion of the plurality of lines, and each line of the first portion passes over each line of the second portion.

8. The flexible memory device of claim 7 wherein the first partially weakened portion is arranged to separate the flexible substrate into a first part and a second part without severing an area common to the first portion of the plurality of lines passing over the second portion of the plurality of lines.

9. The flexible memory device of claim 1 wherein the plurality of contact pads collectively form an area, and the first partially weakened portion is arranged across the area.

10. The flexible memory device of claim 1 wherein the first partially weakened portion is arranged to separate the flexible substrate into a first part and a second part, a first group of the plurality of contact pads are disposed on the first part and a second group of the plurality of contact pads are disposed on the second part.

11. The flexible memory device of claim 1 wherein the plurality of contact pads collectively form an area, and the first partially weakened portion is arranged outside the area.

12. The flexible memory device of claim 1 wherein the first partially weakened portion is arranged to separate the flexible substrate into a first part and a second part and the plurality of contact pads are disposed on the first part.

13. The flexible memory device of claim 1 further comprising:
an adhesive disposed on at least a portion of a first surface of the flexible substrate.

14. The flexible memory device of claim 13 wherein the first partially weakened portion is arranged to separate the flexible substrate into a first part and a second part and the adhesive is disposed on the first part.

15. The flexible memory device of claim 13 wherein the first partially weakened portion is arranged to separate the flexible substrate into a first part and a second part and the adhesive is disposed on a portion of the first part.

16. The flexible memory device of claim 13 wherein the flexible substrate comprises a first part, a second part and a third part, the third part arranged between the first and second parts, the first partially weakened portion arranged across the third part, and the adhesive is disposed on at least a portion of the first part, at least a portion of the second part and/or at least a portion of the third part.

17. The flexible memory device of claim 1 further comprising:
at least one second tamper evident contact pad selected from the plurality of contact pads;
at least one second tamper evident line selected from the plurality of lines and connected to the at least one second tamper evident contact pad; and,
a second partially weakened portion of the flexible substrate arranged across the at least one second tamper evident line.

18. A container comprising the flexible memory device of claim 1.

19. The container of claim 19 further comprising:
an enclosure comprising a sealed portion,
wherein the sealed portion is at least partially formed by the flexible memory device.

20. The container of claim 19 wherein the enclosure is selected from: a bag; a carton; a box; a crate; a can; a bottle; and, an envelope.
